(19) United States
(12) Patent Application Publication
(10) Pub. No.: US 2016/0079778 A1
(43) Pub. Date: Mar. 17, 2016

(54) APPARATUS AND METHOD FOR MANAGING STORED ENERGY

(71) Applicant: WELSENGEN LIMITED, Meopham (GB)

(72) Inventor: Andrew Robert Linton HOWE, Meopham (GB)

(21) Appl. No.: 14/787,720

(22) PCT Filed: Apr. 28, 2014
(86) PCT No.: PCT/EP2014/001125

§ 371 Date: Oct. 28, 2015

(30) Foreign Application Priority Data
Apr. 29, 2013 (GB) 1307651.8
Apr. 29, 2013 (GB) 1307712.8
Mar. 4, 2014 (GB) 1403833.5

(51) Int. Cl. H02J 7/00

(52) U.S. Cl. CPC H02J 7/0016; H02J 7/0021; H02J 7/345

(57) ABSTRACT

There is provided an apparatus for correcting net energy when providing a load balancing service (50) to an electrical power supply network (30). The load balancing service (50) includes one or more energy storage devices which are charged and/or discharged from energy supplied from and/or to the electrical power supply network (30) respectively, wherein the apparatus associated with the one or more energy storage devices is operable to control their state-of-charge (SOC) as a function of an operating frequency (f) of the electrical power supply network (30), and wherein the apparatus is operable to apply a bias of peak high-excursions and/or low-excursions in frequency for ensuring that the one or more energy storage devices are maintained at nominal charge. Beneficially, the apparatus is operable to employ a piecewise linear control algorithm for managing the state-of-charge (SOC) of the energy storage devices.

### TECHNICAL FIELD

The present disclosure relates to apparatus for correcting or managing net energy, for example to apparatus for correcting or managing net energy stored in energy storage devices, for example accumulators, when providing in operation stabilization of electrical supply grids. Moreover, the present disclosure relates to methods of correcting or managing net energy, for example to methods of correcting or managing net energy stored in energy storage devices, for example accumulators, when providing in operation stabilization of electrical supply grids. The present disclosure also relates to apparatus for addressing battery dead-band, for example when providing in operation stabilization of electrical supply grids. Moreover, the present disclosure relates to methods of addressing battery dead-band, for example when providing in operation stabilization of electrical supply grids. Furthermore, the present disclosure relates to software products stored on non-transitory (non-transient) machine-readable data storage carrier and executable upon computing hardware for implementing aforesaid methods.

### BACKGROUND

Electrical supply networks, also known as “grids”, are employed to provide power connections from one or more generators to one or more consumers. Power consumed by the one or more consumers corresponds to a power demand placed upon the one or more generators via the networks. In order to keep operation of the networks stable, it is desirable that there is a balance between power generated by the one or more generators and the power demand. However, both the power demand and the power generated are susceptible to fluctuating as a function of time. For example, the one or more generators include one or more renewable energy sources, for example tidal power and/or wind power for wind turbines. Moreover, the power demand includes one or more users connecting up their electrical vehicles at an end of a working day to recharge their batteries, for example in a situation of plug-in hybrid vehicles.

In order to address the aforementioned situation, it is known to employ smart-grid techniques, for example involving controlling the power demand to match available power generated, for example by selectively switching on and/or switching off various user electrical loads so as to maintain the balance between power generated and power demand. Moreover, it is known to employ energy storage devices coupled to the electrical supply network both to absorb energy when there is excess power generated, and also to release energy when the power generated by the one or more generators is insufficient to meet the power demand. When the energy storage devices are accumulators, for example coupled to the electric supply networks by way of interfacing electronic switching converters, there is a problem with electrical supply network noise, for example in respecting of its alternating synchronous frequency of operation, namely nominally 60 Hz for the USA, and nominally 50 Hz for Europe. When the one or more accumulators are charged or discharged on a basis of the synchronous operating frequency of the electrical supply network, which can deviate from the nominal frequency depending upon instantaneous balance of the electrical supply grid, maintaining a satisfactory battery condition, namely state-of-charge or discharge (SOC), can be a problem, especially when there is considerable aforementioned electrical noise present on the electrical supply networks as power demand fluctuates as a function of time and/or power generated fluctuates as a function of time.

In the UK, National Grid maintains frequency regulation by contracting for frequency regulation services from suppliers. The services provided are concerned with varying energy supplied depending on grid frequency. The services are bi-directional, in that the suppliers can provide both high-response, namely a consumption of net energy, and a low-response response, namely a generation of net energy. Generators provide response power, wherein the power provided varies with frequency, with a defined droop characteristic; this is a normal response. There is an associated characteristic which provides a linear relationship between grid frequency and delivered power, such that in the UK, a generator consumes full response power at 50.5 Hz and delivers full response power at 49.5 Hz. This can be represented by Equation 1 (Eq. 1) within a range of grid frequencies (f) defined by 49.5 Hz<f<50.5 Hz:

$${P}_{response} ( f ) = - \frac{( f - 50 Hz )}{0.5 Hz} \cdot Full\_power \qquad Eq . 1$$

Battery energy storage is able to provide a frequency responsive service. A given battery energy storage is capable of providing both high-responses and low-responses. However, the given battery energy storage can only operate within defined energy storage limits. By way of modifying a response characteristic depending on the state-of-charge SOC) of the given battery energy storage, a smaller battery can be used to provide useful response.

### SUMMARY

The present disclosure seeks to provide an improved apparatus for correcting or managing stored energy, for example when providing a frequency response service to electrical power networks.

Moreover, the present disclosure seeks to provide an improved method of correcting or managing stored energy, for example when providing a frequency response service to electrical power networks.

According to a first aspect, there is provided an apparatus as defined in appended claim 1: there is provided an apparatus for correcting net energy when providing a load balancing service to an electrical power supply network, characterized in that the load balancing service includes one or more energy storage devices which are charged and/or discharged from energy supplied from and/or to the electrical power supply network respectively, wherein the apparatus associated with the one or more energy storage devices is operable to control their state-of-charge (SOC) as a function of an operating frequency (f) of the electrical power supply network, and wherein the apparatus is operable to apply a bias of peak high-excursions and/or low-excursions in frequency for ensuring that the one or more energy storage devices are maintained at nominal charge.

The invention is of advantage in that energy storage capacity of the one or more energy storage devices is employed more effectively for providing a response service.

Optionally, in the apparatus, the energy storage devices include at least one of: sealed Lead acid batteries, inertial flywheel energy storage devices, supercapacitors, air batteries.

Optionally, the apparatus is operable to employ a piecewise linear control algorithm for managing the state-of-charge (SOC) of the energy storage devices.

According to a second aspect, there is provided a method of using an apparatus for correcting net energy when providing a load balancing service to an electrical power supply network, characterized in that the load balancing service includes one or more energy storage devices which are charged and/or discharged from energy supplied from and/or to the electrical power supply network respectively, wherein the methods includes:
(a) operating an apparatus associated with the one or more energy storage devices to control their state-of-charge (SOC) as a function of an operating frequency (f) of the electrical power supply network; and
(b) operating the apparatus to apply a bias of peak high-excursions and/or low-excursions in frequency for ensuring that the one or more energy storage devices are maintained at nominal charge.

Optionally, in the method, the apparatus is operable to employ a piecewise linear control algorithm for managing the state-of-charge (SOC) of the energy storage devices.

According to a third aspect, there is provided a software product recording on machine-readable data storage media, characterized in that the software product is executable upon computing hardware for implementing a method pursuant to the second aspect.

According to a fourth aspect, there is provided an electricity grid including an apparatus pursuant to the first aspect, for providing in operation a response service to the electricity grid.

According to a fifth aspect, there is provided an apparatus for addressing battery dead-band when providing a load balancing service to an electrical power supply network, characterized in that the load balancing service includes one or more energy storage devices which are charged and/or discharged from energy supplied from and/or to the electrical power supply network respectively, wherein the apparatus associated with the one or more energy storage devices is operable to control their state of charge as a function of an operating frequency (f) of the electrical power supply network, and wherein the apparatus is operable to apply a hysteresis response to discharging and recharging of the one or more energy storage devices to reduce a number of recharge and charging cycles otherwise caused by noise present in the operating frequency (f), wherein the hysteresis response is applied as a plurality of dead-bands to a plurality of groups of the one or more energy storage devices, wherein the dead-bands are mutually overlapping and are selected so that the one or more devices are maintained in operating region which avoids overcharging and deep discharging of the one or more energy storage devices.

Optionally, in the apparatus, the energy storage devices include at least one of: sealed Lead acid batteries, inertial flywheel energy storage devices, supercapacitors, air batteries.

According to a sixth aspect, there is provided a method of addressing battery dead-band when providing a load balancing service to an electrical power supply network, characterized in that the load balancing service includes one or more energy storage devices which are charged and/or discharged from energy supplied from and/or to the electrical power supply network respectively, wherein an apparatus associated with the one or more energy storage devices is operable to control their state of charge as a function of an operating frequency (f) of the electrical power supply network, wherein the method includes:
(a) using the apparatus to apply a hysteresis response to discharging and recharging of the one or more energy storage devices to reduce a number of recharge and charging cycles otherwise caused by noise present in the operating frequency (f);
(b) applying the hysteresis response as a plurality of dead-bands to a plurality of groups of the one or more energy storage devices, wherein the dead-bands are mutually overlapping and are selected so that the one or more devices are maintained in operating region which avoids overcharging and deep discharging of the one or more energy storage devices.

According to a seventh aspect, there is provided a software product recording on machine-readable data storage media, characterized in that the software product is executable upon computing hardware for implementing a method pursuant to the sixth aspect.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to following drawings, wherein:

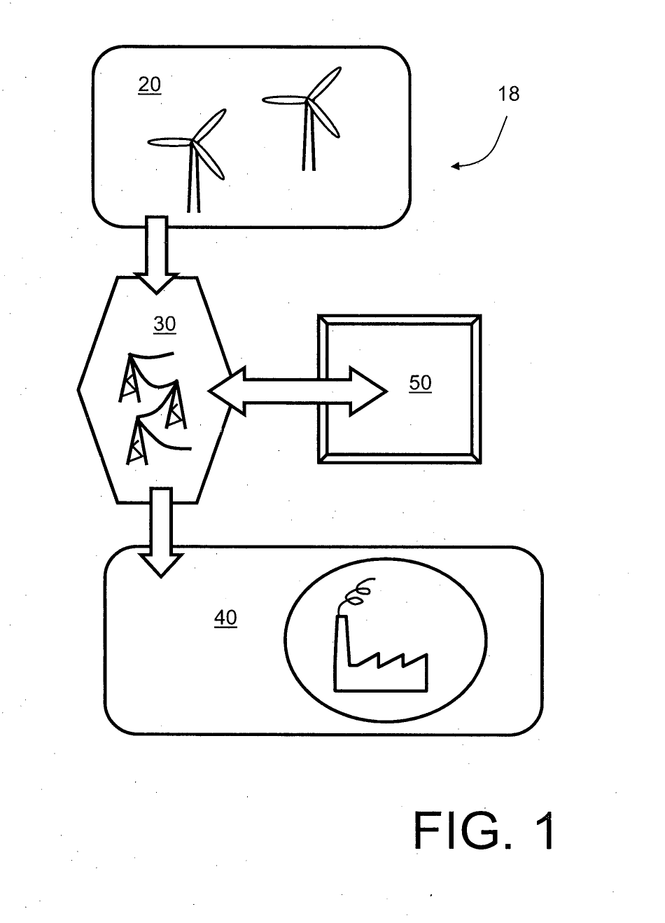

FIG. 1 is an illustration of an electrical supply system including an electrical supply network, one or more generators, one or more power consumers and a load balancing apparatus including one or more accumulators for receiving and/or supply energy to the electrical supply network to assist to load balance the electrical supply network;

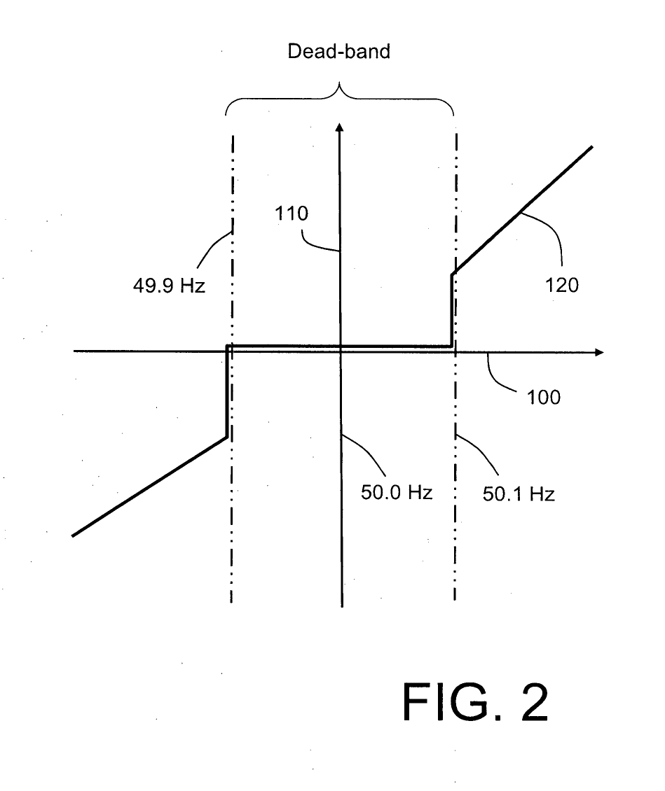

FIG. 2 is an illustration of a load balancing response from the load balancing apparatus in FIG. 1; and

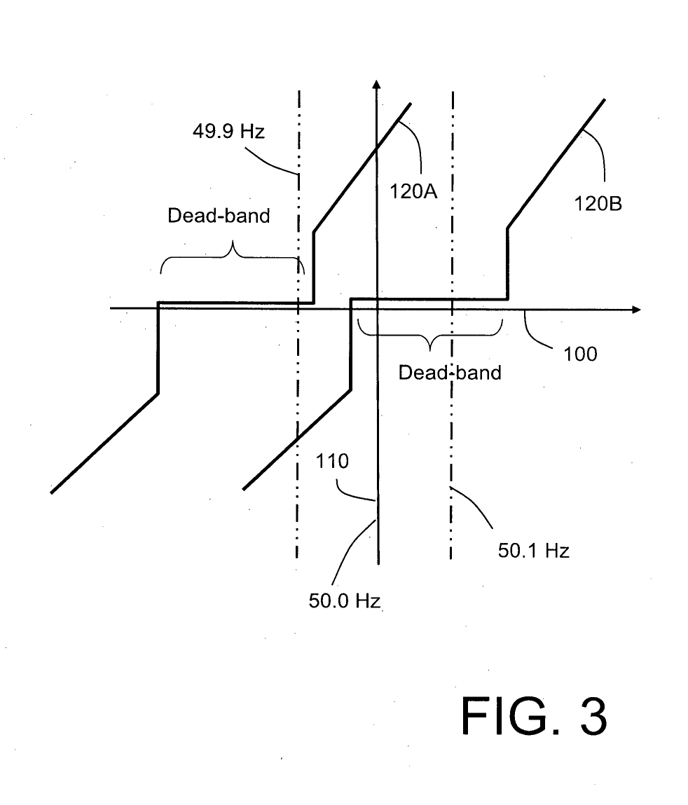

FIG. 3 is an illustration of an alternative load balancing response from the load balancing apparatus in FIG. 1.

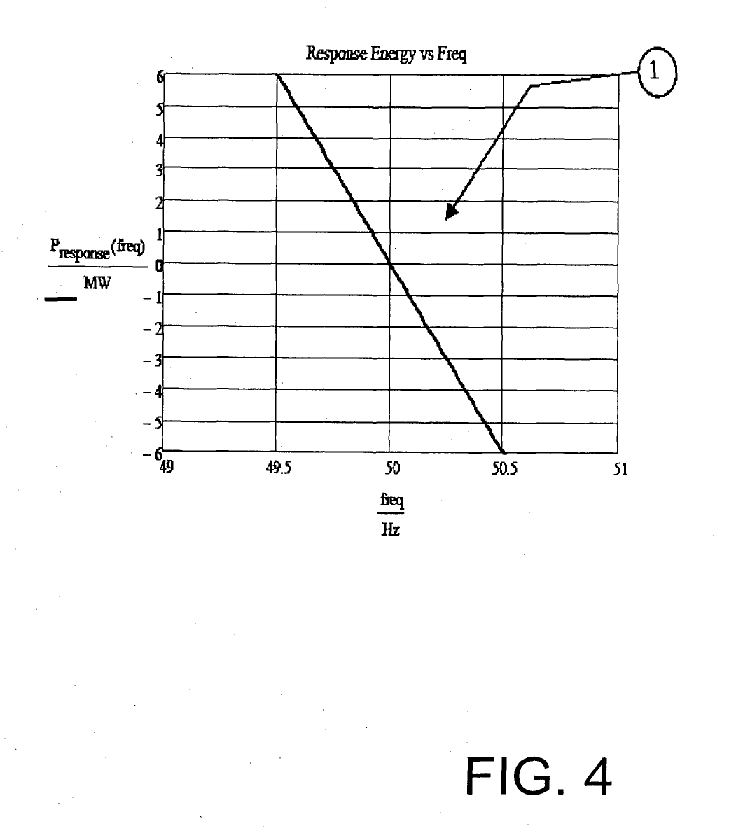

FIG. 4 is an illustration of a response power delivered from a typical generator which is connected to the grid and providing frequency response; in the illustration, a characteristic 1 is ideally a linear relationship, wherein a delivered power varies with frequency; in the UK, there is provided a nominal grid frequency is 50.000 Hz and the ideal characteristic is zero response power; in the example shown, 6 MW of low response is delivered at 49.5 Hz and 6 MW of high response is delivered at 50.5 Hz;

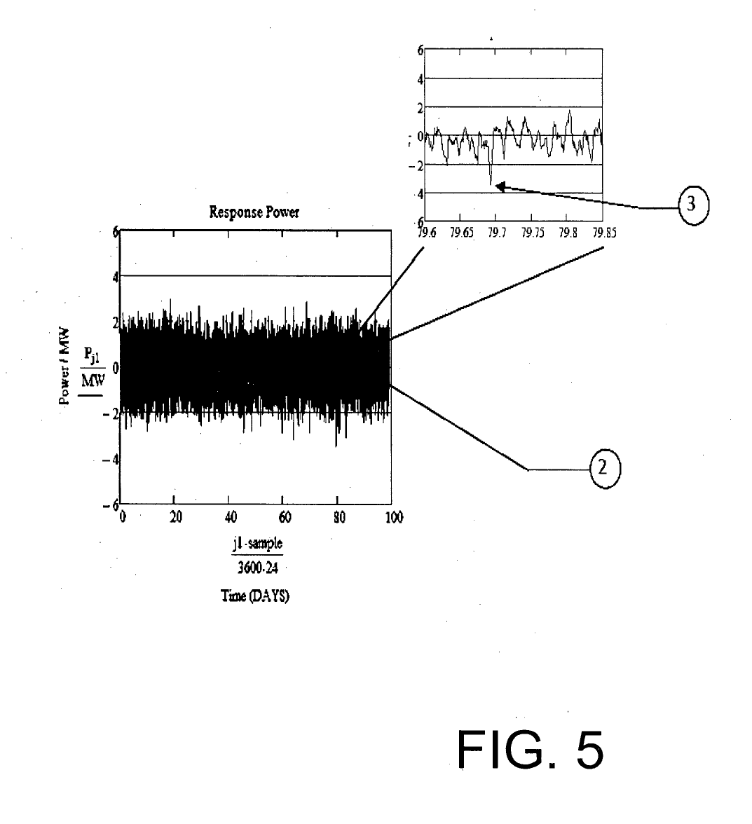

FIG. 5 is an illustration of a variation of grid frequency as a function of time 2, over a period of 100 days, namely commencing 17 Jun. 2013; a frequency history 3 is an expanded portion of the characteristic 1, over a magnified scale of 6 hours;

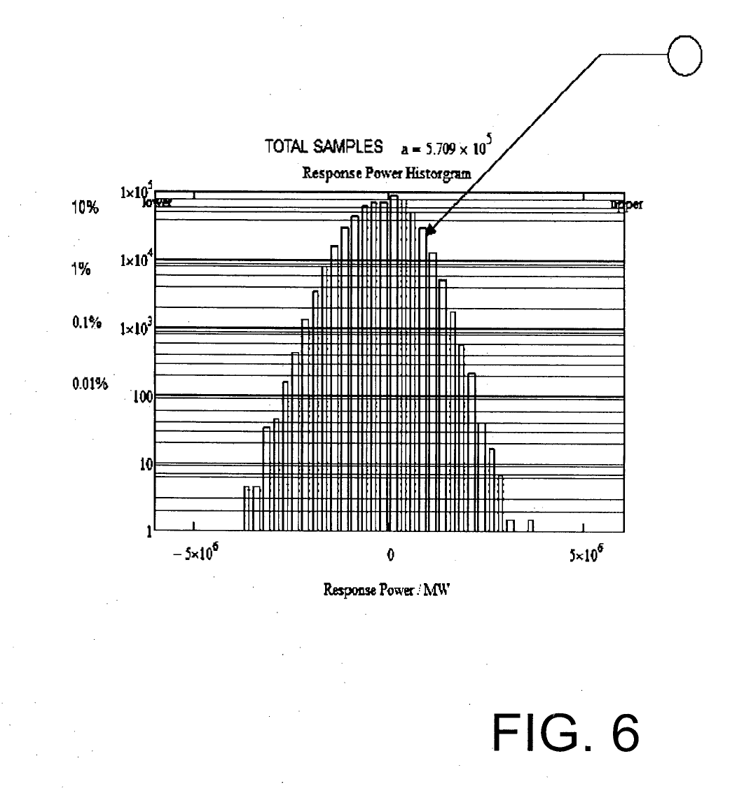

FIG. 6 is a histogram of the response power delivered by an ideal generator with the frequency characteristic 1, when subject to the frequency history, 2; the histogram has a y-axis which depicts a log scale, and in total there are 0.57 million data points corresponding to a 15 second resolution;

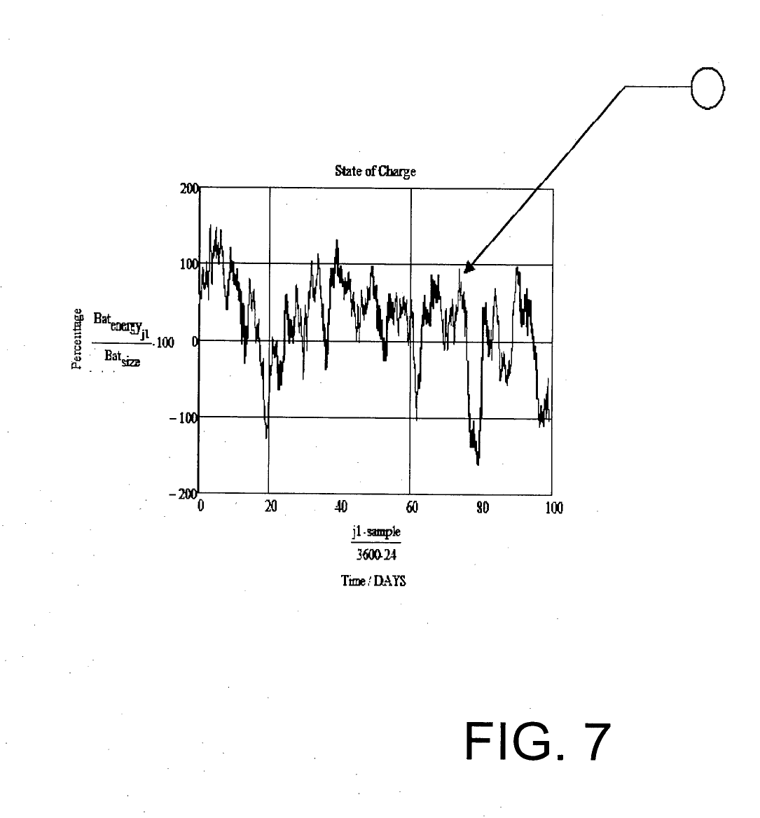

FIG. 7 is an illustration of a state-of-charge (SOC) of an accumulator with a storage capacity of 5.5 MWh, when providing the response power defined by the characteristic 1, with respect to grid frequency, 2; The battery starts from a SOC which is nominally 50% of its capacity; in such a modelled scenario, it will be appreciated that the capacity of the battery is exceeded with SOC ranging from −160% to 149%; more practically, an 18 MWh battery an be potentially used without exceeding its full SOC range; however, this larger capacity battery will be more than three times as expensive in contradistinction to other solutions described in the disclosure;

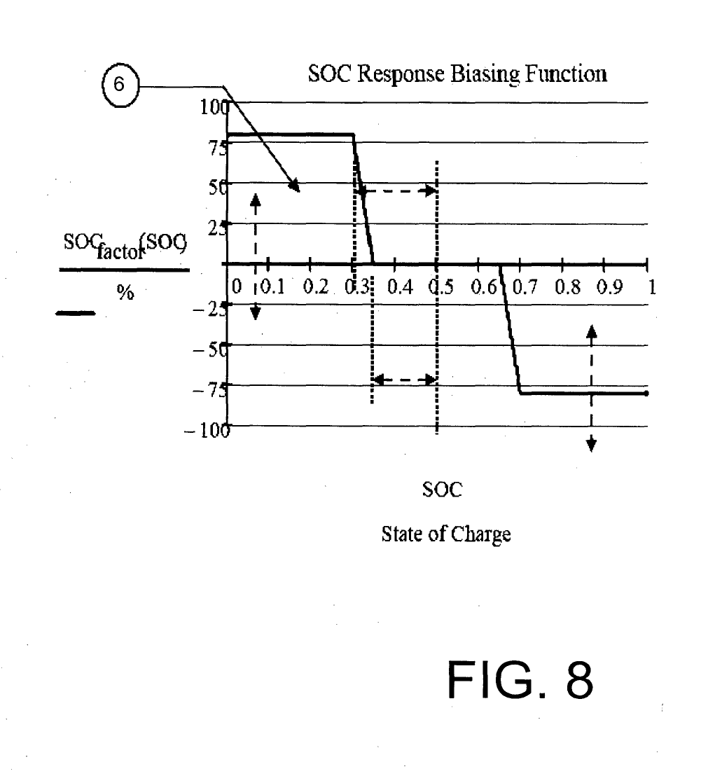

FIG. 8 is an illustration of a SOC biasing function, 6, whose characteristic is set by three constants k₁, k₂ and k₃;

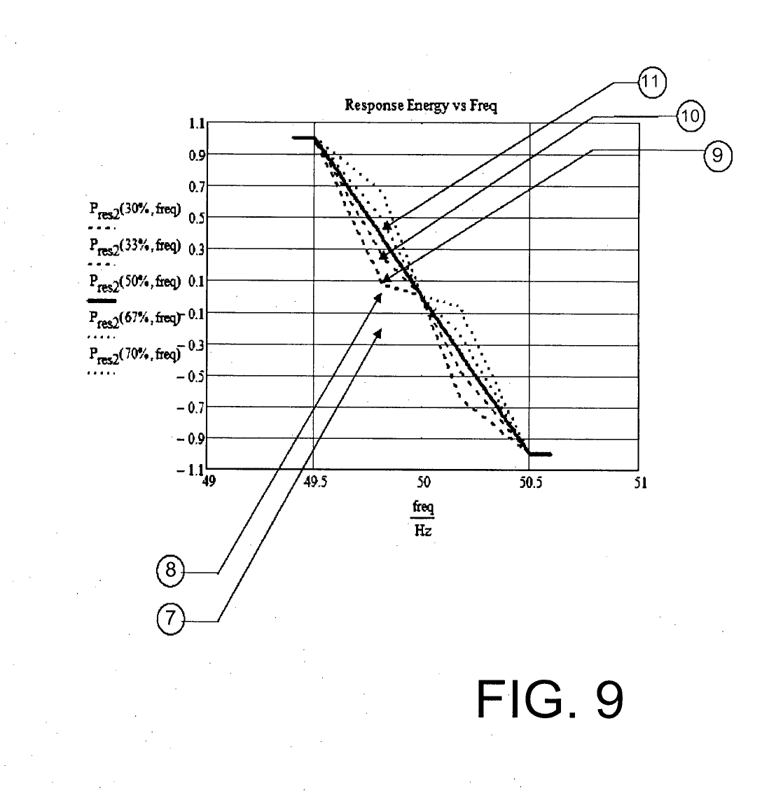

FIG. 9 is an illustration of several modified response power as a function of frequency characteristics, 7, 8, 9, 10 and 11 which are applied depending on the SOC biasing function, 6;

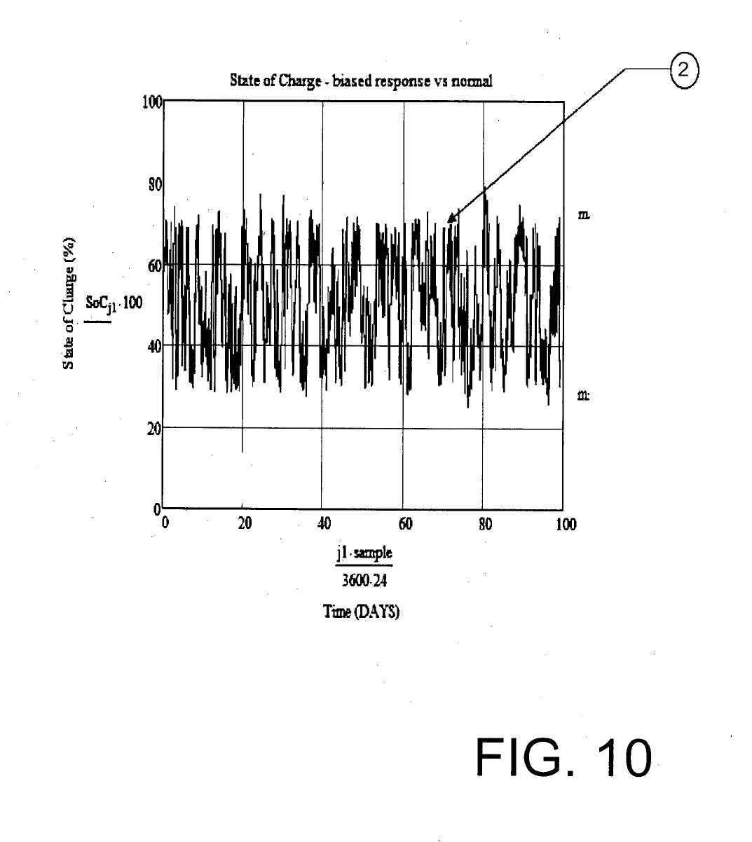

FIG. 10 is an illustration the battery state-of-charge (SOC) for a 5.5 MWh battery, when the frequency history, 2, is applied to modified response characteristics selected based on the current battery state-of-charge; the state-of-charge variation is substantially improved, and an associated response system can operate with a 5.5 MWh battery, while retaining sufficient energy storage to respond to a potential grid fault condition, such as a generator failure, which may potentially cause the grid frequency to drop or increase, requiring full delivery of response power for the duration of the fault condition;

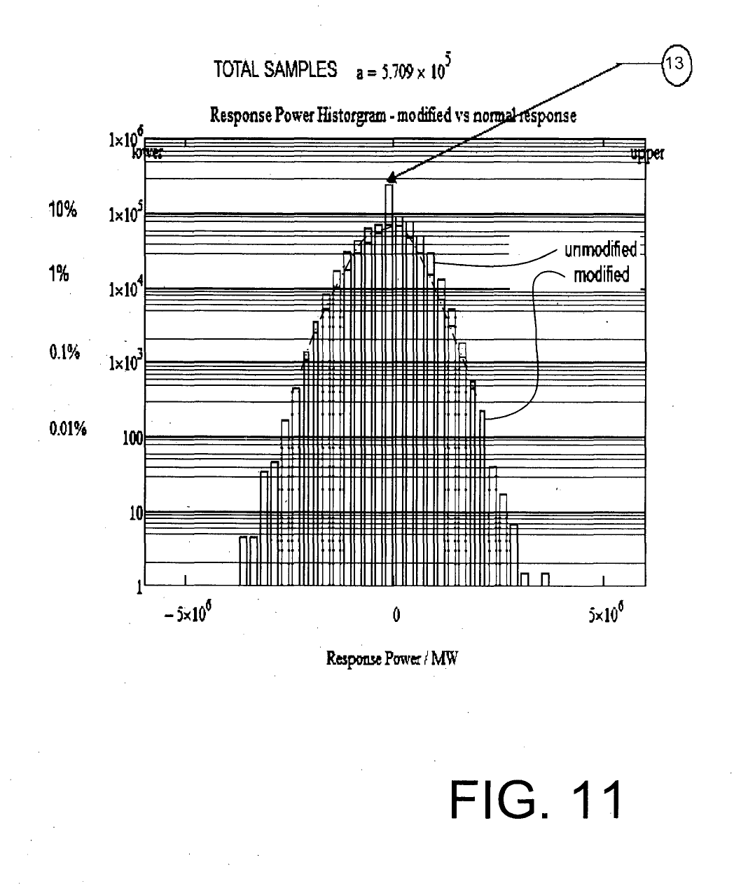

FIG. 11 is a histogram 13, of response power delivered for the biased modified response characteristics; it will be appreciated that the total response energy is substantially the same, namely an advantageous characteristic; and

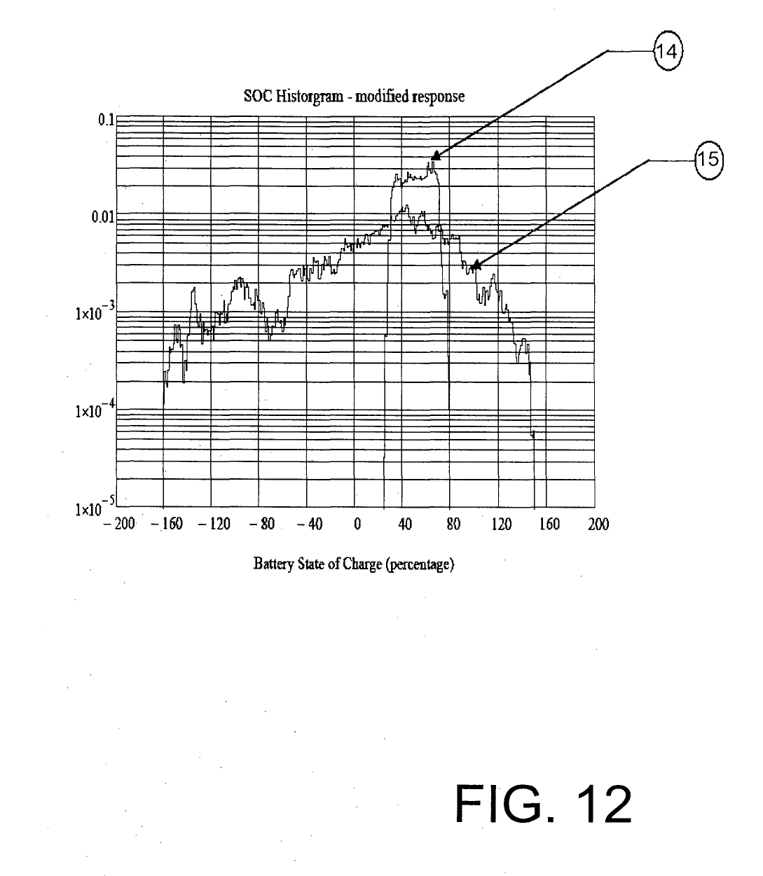

FIG. 12 is a histogram, alternatively a probability distribution function graph, of the battery state-of-charge that is experienced when applying the same grid frequency history, 2, to the biased modified response characteristics, namely as illustrated in a histogram 14, when compared to the normal generator response characteristic as illustrated in a histogram 15; the vastly reduced state of charge range, and hence size of battery, is clearly demonstrated here.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE DISCLOSURE

In overview, with reference to FIG. 1, an electrical supply system, indicated generally by 18, includes one or more power generators 20, an electrical supply network 30, and one or more consumers 40. The one or more power generators 20 include, for example, one or more of: coal-fired power stations, wind turbines, geothermal energy generators, solar cells, gas turbine generators, nuclear power plant, ocean wave energy generating plant, ocean thermal energy generators. The one or more consumers 40 include factories, hospitals, schools, domestic premises, transport systems, but not limited thereto. The electrical supply network 30 includes overhead gantry pylons, grounds cables, switching stations, transformers and such like.

It is conventional practice to operate the electrical supply system 18 with an alternating current (a.c.) form of electricity, which is usually at a nominal operating frequency f₀ of 60 Hz for USA, and 50 Hz for Europe. In operation, an operator of the electrical supply system 18 attempts to match power, at every moment, generated by the one or more generators 20 with power demand exhibited by the one or more consumers 40. In practice, such matching is not perfect, such that the aforementioned nominal operating frequency f₀ is not perfectly maintained, for example as expressed by Equation 1 (Eq. 1):

$$\sum {\int }_{0}^{day} ( hi\_excursion ) d f - \sum {\int }_{0}^{day} ( lo\_excursion ) d f \neq 0 \qquad Eq . 1$$

wherein

hi_excursion=frequency excursions above the nominal frequency f₀; and

lo_excursion=frequency excursions below the nominal frequency f₀.

When the electrical supply system 18 is implemented pursuant to the present disclosure, a load balancing service 50 is coupled to the electrical supply network 30, wherein the load balancing service 50 includes one or more rechargeable accumulators, for example sealed Lead acid batteries (SLA), although types of battery such as Lithium-based batteries are alternatively employed. When the one or more consumers 40 consume more power than the one or more generators 20 can generate for a short period, the load balancing service 50 is operable to supply power derived from the one or more accumulators to the electrical supply network 30. Moreover, in periods when the one or more generators are generating more power than required by the one or more consumers, the load balancing service is operable to recharge its one or more accumulators again.

In order to keep the one or more accumulators in a satisfactory state-of-charge (SOC), they must be neither over-charged nor deeply discharged. Overcharging causes an electrolyte within the one or more accumulators to be electrolysed to gaseous components, whereas deep discharge can cause irreversible precipitate chemical reactions within the one or more accumulators.

A charging circuit of the one or more accumulators, for example including one or more computing devices, implements decisions regarding discharging, namely to supply energy to the electrical supply network 30, or recharging, namely to absorb energy from the electrical supply network 30, depending upon an instantaneous frequency f of the system 18. The instantaneous frequency f, as defined in Equation 1 (Eq. 1) should average to the nominal frequency f₀, but often does not in practice. Moreover, the instantaneous frequency f is potentially a noisy signal as complex types of loads at the one or more consumers 40 are switched on and off. It is thus found that controlling discharging and charging of the one or more accumulators based on the instantaneous frequency f is unreliable, and can result in premature degradation of the one or more accumulators when in operation providing an aforementioned response service.

In order to address problems of unreliable discharging and charging of the one or more storage devices, for example sealed Lead acid accumulators, a hysteresis is beneficially employed in a discharge and recharging regime employed in the load balancing service 50 as illustrated in FIG. 2, wherein a dead-band corresponds to an applied hysteresis. In FIG. 2, an abscissa axis 100 denotes instantaneous grid operating frequency f, wherein 50.0 Hz corresponds to the nominal grid frequency f₀. An ordinate axis 110 denotes charging and discharging operations from the one or more energy storage devices. Optionally, the dead-bands for the one or more energy storage devices are randomized within the one or more energy storage devices; in other words, the one or more energy storage devices are sub-divided into a plurality of groups, wherein each group is controlled to have a corresponding hysteresis and associated dead-band for charging and discharging. Beneficially, the dead-bands are randomized, for example as a function of time. For example, in FIG. 3, there are shown two mutually concurrently employed different dead-bands employed for the one or more energy storage devices providing charging and discharging responses as denoted by 120A, 120B. The dead-bands are applied so that the one or more energy storage devices are not overcharged or excessively discharged, that the load balancing service 50 assists to maintain the instantaneous (synchronous operating) frequency f nominally at the nominal frequency f₀, and that noise in the instantaneous (synchronous operating) frequency f does not cause the load balancing service 50 to switch too frequently between discharging and recharging of the one or more energy storage devices, which could otherwise potentially cause excessive cycling and diminish the operating lifetime of the one or more energy storage devices, for example the aforesaid one or more sealed Lead acid accumulators.

Although reference is made to one or more accumulators in the load balancing service 50, it will be appreciated that other types of energy storage devices can be additional or alternatively employed therein, for example inertial energy storage (vacuum flywheels), Lithium rechargeable batteries, Zinc Oxide air batteries, supercapacitors and such like.

A solution to providing the load balancing service 50 is to bias one of peak excursions experienced by the load balancing service 50, for example a hi_excursion and/or a lo_excursion as appropriate. It is then subsequently possible to execute a “catch up” on the state-of-charge (SOC) of the one or more accumulators by biasing a peak response provided by the load balancing service 50. Such catch-up can be implemented:
(a) as a running average (namely continuous catch-up); or
(b) by defining by way of time bands, for example 00:00 hrs to 04:00 hrs, when catch-up is implemented; or
(c) by negotiating with an operator of the electrical supply network 30, for example National Grid (NG) regarding a new response peak frequency.

Embodiments of the present disclosure are beneficially applied to a grid-connected energy storage system which comprises a large battery constructed from thousands of individual cells together with one or more active battery management systems, connected to both a grid connected rectifier and an invertor system which provide the charging and discharging of the storage battery. A grid frequency measurement device provides instantaneous grid frequency measurements to computing hardware of the one or more active battery management systems. The one or more battery management systems provide an aggregated battery storage state-of-charge (SOC) measurement to the same computing hardware. The computing hardware is operable to control the rectifier and also to command the response power as required based on the measurements of current battery state-of-charge (SOC) and instantaneous grid frequency f.

A detailed description of a method of operating the aforementioned computing hardware will now be described with reference to FIG. 4 to FIG. 12, with reference to underlying mathematical equations defining computations executed within the computing hardware.

A state-of-charge (SOC) bias function is calculated from the measurement of the current battery state-of-charge (SOC). There are three defining constants which may be varied to provide differing response characteristics and these are illustrated in FIG. 8. A constant k₁ defines a band of states-of-charge (SOC) in which the normal generator response characteristic is applied. A constant k₂ defines a band over which a variable bias characteristic is applied. A constant k₃ defines a maximum state-of-charge (SOC) bias characteristic.

In this embodiment, a piecewise linear characteristic centred at a target nominal state of charge SOCₙₒₘ can be defined by a relationship in Equation 2 (Eq. 2):

SOC_{factor}(x):=−if [x<p₁,−k₃, if [x<p₂,−k₄·(−x+p₂), if [x<p₃,0₃ if [x<p₄,k₄·(x−p₃),k₃]]]] Eq. 2

wherein inflection points are as follows:

| | |
|---|---|
| p₁ := SOCₙₒₘ − k₂ | p2 := SOCₙₒₘ − k₁ |
| p₃ := SOCₙₒₘ + k₁ | p4 := SOCₙₒₘ + k₂ |

The relation in Equation 2 establishes a SOC bias factor which is dependent of the measured state-of-charge (SOC).

The modified response energy versus grid frequency characteristic is computed using the measured state-of-charge (SOC) and the measured instantaneous grid frequency, f. The characteristic is again piecewise linear and possess potentially two gradients. The gradients change at two points of frequency which are symmetrically offset from the nominal frequency, f₀. In the UK, National Grid, namely an electric supply network operator for the UK, is required to maintain the normal grid frequency f₀ within a band 49.8 Hz<f<50.2 Hz. Any excursion outside this band is regarded as abnormal operation. Such an operational characteristic allows for the computing hardware to switch the gradient in the knowledge that operation outside a defined band is abnormal and a fault condition.

The gradients are chosen so that, if the state-of-charge (SOC) lower than desired (i.e. outside the region defined by the constant k₁), a modified response characteristic is selected. The characteristic 8, is selected at 33% SOC and a maximum bias (set by the constant k₃) characteristic, 9 is beneficially set by SOC 30%. It will be appreciated that for SOC less than a lower range set by the constant k₁, the characteristic is like a normal generator, gradually transitioning as SOC deviates to more aggressive “correcting” characteristics. Moreover, it will be appreciated that, at a low state-of-charge (SOC), the modified bias characteristic cause the load balancing service 50 to output less (low frequency) discharging response within the normal operational grid frequency range, and more (high frequency) charging response. Similarly, if the state-of-charge (SOC) is higher than nominal, the corresponding opposite characteristic will cause battery state-of-charge (SOC) to return to nominal. By appropriately reducing or increasing the power in and out of the battery within the normal operation frequency band depending on the measured state of charge, the computing hardware will cause the battery state-of-charge (SOC) to return towards the nominal SOC. The symmetry of the characteristics means that the integral of the delivered response power/energy averaged over long times is equal.

In this embodiment, the delivered response power as a function of current measured state-of-charge (SOC) and instantaneous grid frequency f is defined by Equation 3 (Eq. 3):

Pᵣₑₛ₂(s,f):=if [f<(p₁),1, if [p₂,1−m₂(s)·(f−p₁), if [f<p₃,−m₁(s)·(f−p₃), If [f<p₄,0, if [f<p₅,−m₁(1−s)·(f−p₄), if [f<p₆,m₂(1−s)·(p₆−f)−1,−1]]]]] Eq. 3

wherein inflection points are defined by:

| | |
|---|---|
| p₁ := Full_low | p₂ := freq_nom − Bias |
| p₃ := freq_nom − deadband | p₄ := freq_nom + deadband |
| p₅ := freq_nom + Bias | p₆ := Full_high |

and the frequency band characteristics full_low, full_high, freq_nom and bias are grid frequency characteristics. For UK operation, as aforementioned, these inflexion points are set to give inflection points as follows:

| | | |
|---|---|---|
| p₁ = 49.5 Hz | p₂ = 49.82 Hz | p₃ = 50.0 Hz |
| p₄ = 50.0 Hz | p₅ = 50.18 Hz | p₆ = 50.5 Hz |

An optional dead-band, not shown in FIG. 9, is inherent in the Equation 3 (Eq. 3) defined above. This dad-band defines a region where zero response power is delivered, and is one method of avoiding the whole response service 50 switching from charge to discharge rapidly and continuously, if the grid frequency and measurement error were to remain around 50.000 Hz. Alternatively, hysteresis is optionally employed.

In operation of the system, the constants k₁, k₂ and k₃ are set to maintain the state-of-charge (SOC) within a defined and restricted band around the nominal SOC. This provides energy headroom to provide response to energy grid faults which have defined and known characteristics. In the UK, a power grid system operator is required to plan for single fault tolerance, which, for low frequency events, is the loss of the largest generation station (for example, Sizewell nuclear power plant (UK) at the time of submitting the present disclosure) and this potentially causes a grid frequency excursion to around 49.2 Hz to occur within 10 seconds. If low frequency response energy supplied to the electrical power network 30, namely grid, does not restore net energy balance between consuming loads and generation, then grid frequency f continues to reduce over a few more seconds, until mandatory load shedding blacks out defined subsets of consumers 40, reducing load and restoring energy balancing. Similarly, the worst high frequency events cause grid frequency f to rise, requiring battery energy storage systems to consume and charge their battery.

The aforesaid computing hardware beneficially has a plurality of desirable features as illustrated and described. Firstly, the state-of-charge (SOC) is managed to a tighter band, reducing the required battery size, irrespective of a previous history of the grid frequency f. The inherent SOC is related to an integral of grid frequency relationship is broken. The long term average of the response power delivered is identical to that of the generator. Moreover, the long term average frequency versus response power characteristic is maintained. Full response power is always delivered during worst case events. Assuming a given system operator were to manage the grid synchronous time clock error within a defined band, then the constant k₁ constant and battery can be adjusted to provide an unbiased normal response as would be expected from a generator.

Furthermore, the system described in the foregoing is linear and deterministic, and does not depend on averaging the grid frequency f or using the history of grid frequency f, or using populations of devices. The system is beneficially modelled by conventional feedback linear systems, for example for verifying its operating reliability in adverse grid conditions.

The nominal state-of-charge, and the operating band for state-of-charges are optionally deliberately chosen to operate in regions advantageous for the battery storage chemistry of the energy storage device by appropriate selection of the defining characteristics, as aforementioned.

While the embodiment described above uses a piecewise linear function to define the state-of-charge biasing function and the modified response power characteristic, it is possible to use almost any mathematical function that has the important characteristics identified that allows for a correcting bias to be applied in the normal grid operating frequency range, while allowing for full response power delivery. Moreover, by alleviating the requirement for equal power delivery across defined frequency ranges, less desirable but workable characteristics may be obtained.

Similarly non-symmetric corrections to the biasing algorithms are optionally applied to correct for unequal losses in the charging/discharging circuits which may also cause SOC bias, although the aforementioned described system will correct for these automatically. Moreover, the state-of-charge management characteristics are optionally applied to individual sub-units within the battery storage. This beneficially allows for portions of the battery to be run into defined state of charges for managing battery/cell balancing.

While the described embodiments are highly advantageous to battery energy storage providing frequency response, it can equally apply to any energy storage device, whether it is based upon hydroelectric energy storage, compressed air energy storage, liquefied air energy storage, mechanical flywheel energy storage, supercapacitor energy storage, populations of load devices or others known in the art.

Within a group of batteries employed for implementing the response service, as described above, the batteries are optionally operated in mutually different states of discharge, within high and low charge state limits. Alternatively, the batteries are optionally operated in mutually similar states of discharge, within high and low charge state limits. Optionally, battery technologies employed includes Lithium Titanate batteries and/or Barium Titanate batteries, which are well suited for immediate, namely high CV, powers over short periods of time, but with long operating life, for example employed in combination for Lead acid batteries (for example SLA-type sealed Lead acid gel batteries).

Other embodiments of the disclosure will now be described.

A state-of-charge bias function is introduced, defined by Equation 4 (Eq. 4):

SOC_{factor}(x):=−if [x<p₁,−k₃, if [x<p₂,−k₄·(−x+p₂), If [x<p₃,0, if [x<p₄,k₄·(x−p₃),k₃]]]] Eq. 4

wherein x is the state-of-charge (SOC), and a constant k₁ defines a deadband about which no correction is applied and response is normal, a constant k₂ defines an upper limit at which SOC factor is capped, and a constant k₃ is the cap on modification factor, for example:

| | | | |
|---|---|---|---|
| k₁ := 5% | k₂ := 15% | k₃ := 20% | SOCₙₒₘ := 50% |

constants defining function

k₄:=k₃/(k₁−k₂)
various points in a response function

| | | |
|---|---|---|
| p₁ := SOCₙₒₘ − k₂ | p₂ := SOCₙₒₘ − k₁ | p₃ := SOCₙₒₘ + k₁ |
| p₄ := SOCₙₒₘ + k₂ | | |

The SOC factor is a function varying from +k₃ to −k₃, depending upon the battery state-of-charge (SOC).

The SOC factor is used to modify the response characteristic, wherein the response characteristics is a piecewise linear function with five regions and is defined by Equation 5 (Eq. 5):

Pᵣₑₛ₂(s,f):=if [f<(p₁),1,if [f<p₂,1−m2(s)·(f−p₁),if [f<p₃,−m₁(s)·(f−p₃), if [f<p₄,0, if [f<p₅,−m₁(s)·(f−p₄), if [f<p₆,m₂(s)·(p₆−f)−1,−1]]]]]] Eq. 5

wherein inflexion points are as follows:

| p₁ := Full-low | p₂ := freq_nom − Bias | p₃ := freq-nom − deadband |
|---|---|---|
| p₄ := freq_nom + deadband | | p₅ := freq_nom + Bias |
| p₆ := Full_high | | |

namely, for example,

| | | |
|---|---|---|
| p₁ = 49.5 Hz | p₂ = 49.82 Hz | p₃ = 49.98 Hz |
| p₄ = 50.02 Hz | p₅ = 50.18 Hz | p₆ = 50.5 Hz |
| P_{f} := Full_power | | |

and points and gradients defining modified response function are such that:

a gradient of the first portion is defined by Equation 6 (Eq. 6):

$${m}_{1} ( SOC ) = \frac{HiNom ( 1 - {SOC}_{factor} ( SOC ) )}{( HiBias\_freq \_nom - deadband )} \qquad Eq . 6$$

wherein the SOC factor is used to modify the response characteristics,

and a gradient of second portion is defined by Equation 7 (Eq. 7):

$${m}_{2} ( SOC ) = \frac{1 - HiNom ( 1 - {SOC}_{factor} ( SOC ) )}{full\_high - HiBias} \qquad Eq . 7$$

An alternative method optionally modifies the response by applying the correction to grid frequency measurement, wherein response and grid frequency deviation from nominal are both linear and proportional.

Alternatively, a filter is optionally applied to grid frequency or response, which effectively reduces the low frequency time varying components of grid frequency, analogous to an a.c. coupling technique which avoids the state-of-charge (SOC) continuously heading low over a period of time.

The state-of-charge (SOC) is directly related to synchronous clock error, namely the time measured on a clock driven from mains frequency will measure the integral of grid frequency, which is time. Most grid operators will target a maximum time error, as clocks do sometimes use mains for keeping time, but increasingly this requirement is being relaxed. In the UK, real grid data presented in FIG. 4 to FIG. 12 set the peak time error to be around 20 seconds.

Alternatively, differentiation-type functions applied to the frequency history, are a form of filter which has zero response to DC and linear increasing responses to faster fluctuations, and is beneficially employed in embodiments of the disclosure described in the foregoing.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. An apparatus for correcting net energy when providing a load balancing service (50) to an electrical power supply network (30), characterized in that the load balancing service (50) includes one or more energy storage devices which are charged and/or discharged from energy supplied from and/or to the electrical power supply network (30) respectively, wherein the apparatus associated with the one or more energy storage devices is operable to control their state-of-charge (SOC) as a function of an operating frequency (f) of the electrical power supply network (30), and wherein the apparatus is operable to apply a bias of peak high-excursions and/or low-excursions in frequency for ensuring that the one or more energy storage devices are maintained at nominal charge.

2. An apparatus as claimed in claim 1, wherein the energy storage devices include at least one of: sealed Lead acid batteries, inertial flywheel energy storage devices, supercapacitors, air batteries.

3. An apparatus as claimed in claim 1, wherein the apparatus is operable to employ a piecewise linear control algorithm for managing the state-of-charge (SOC) of the energy storage devices.

4. A method of using an apparatus for correcting net energy when providing a load balancing service (50) to an electrical power supply network (30), characterized in that the load balancing service (50) includes one or more energy storage devices which are charged and/or discharged from energy supplied from and/or to the electrical power supply network (30) respectively, wherein the methods includes:
(a) operating an apparatus associated with the one or more energy storage devices to control their state-of-charge (SOC) as a function of an operating frequency (f) of the electrical power supply network (30); and
(b) operating the apparatus to apply a bias of peak high-excursions and/or low-excursions in frequency for ensuring that the one or more energy storage devices are maintained at nominal charge.

5. A method as claimed in claim 4, wherein the apparatus is operable to employ a piecewise linear control algorithm for managing the state-of-charge (SOC) of the energy storage devices.

6. A software product recording on machine-readable data storage media, characterized in that the software product is executable upon computing hardware for implementing a method as claimed in claim 4.

7. An electricity grid including an apparatus as claimed in claim 1, for providing in operation a response service to the electricity grid.

8. An apparatus for addressing battery dead-band when providing a load balancing service (50) to an electrical power supply network (30), characterized in that the load balancing service (50) includes one or more energy storage devices which are charged and/or discharged from energy supplied from and/or to the electrical power supply network (30) respectively, wherein the apparatus associated with the one or more energy storage devices is operable to control their state-of-charge (SOC) as a function of an operating frequency (f) of the electrical power supply network (30), and wherein the apparatus is operable to apply a hysteresis response (120) to discharging and recharging of the one or more energy storage devices to reduce a number of recharge and charging cycles otherwise caused by noise present in the operating frequency (f), wherein the hysteresis response (120) is applied as a plurality of dead-bands to a plurality of groups of the one or more energy storage devices, wherein the dead-bands are mutually overlapping and are selected so that the one or more devices are maintained in operating region which avoids overcharging and deep discharging of the one or more energy storage devices.

9. An apparatus as claimed in claim 8, wherein the energy storage devices include at least one of: sealed Lead acid batteries, inertial flywheel energy storage devices, supercapacitors, air batteries.

10. A method of addressing battery dead-band when providing a load balancing service (50) to an electrical power supply network (30), characterized in that the load balancing service (50) includes one or more energy storage devices which are charged and/or discharged from energy supplied from and/or to the electrical power supply network (30) respectively, wherein an apparatus associated with the one or more energy storage devices is operable to control their state-of-charge (SOC) as a function of an operating frequency (f) of the electrical power supply network (30), wherein the method includes:
(a) using the apparatus to apply a hysteresis response (120) to discharging and recharging of the one or more energy storage devices to reduce a number of recharge and charging cycles otherwise caused by noise present in the operating frequency (f);
(b) applying the hysteresis response (120) as a plurality of dead-bands to a plurality of groups of the one or more energy storage devices, wherein the dead-bands are mutually overlapping and are selected so that the one or more devices are maintained in operating region which avoids overcharging and deep discharging of the one or more energy storage devices.

11. A software product recording on machine-readable data storage media, characterized in that the software product is executable upon computing hardware for implementing a method as claimed in claim 10.
